(19) United States
(12) Patent Application Publication
(10) Pub. No.: US 2005/0124359 A1
(43) Pub. Date: Jun. 9, 2005

(54) Multi-port interface for a switched wireless network

(76) Inventors: Bruce A. Willins, East Northport, NY (US); Huayan Amy Wang, Hauppague, NY (US)

Correspondence Address: WILLIAMS, MORGAN & AMERSON, P.C., 10333 RICHMOND, SUITE 1100, HOUSTON, TX, 77042, US

(21) Appl. No.: 10/730,415

(22) Filed: Dec. 8, 2003

(51) Int. Cl. H04Q 7/20

(52) U.S. Cl. 455/466

(57) ABSTRACT

A method and apparatus are provided. The method comprises receiving, using a wireless controller, data transmitted from one or more wireless transmitters adapted to communicate with a plurality of mobile terminals, receiving descriptive information associated with at least a portion of the received data from the one or more wireless transmitters and providing the received data and the associated descriptive information to a port interface associated with the wireless controller.

### BACKGROUND OF THE INVENTION

1. Field of the Invention

This invention relates generally to wireless networks, and, more particularly, to a multi-port interface for a switched wireless network.

2. Description of the Related Art

A Wireless Local Area Network (WLAN) is a flexible data communications system that can either replace or extend a wired LAN to provide added functionality. A traditional, wired local area network (LAN) sends packets of data from one piece of equipment to another across cables or wires. A wireless local area network (WLAN) relies instead upon radio waves to transfer data. Data is superimposed onto a radio wave through a process called modulation, and this carrier wave then acts as the transmission medium, taking the place of a wire.

The importance of WLAN technology, however, goes beyond just the absence of wires. The advent of WLAN technology opens up a whole new definition of what a network infrastructure can be. No longer does an infrastructure need to be solid and fixed, difficult to move, and expensive to change. Instead, it can move with the user and change as fast as the organization does. For example, business people can stay connected as they move throughout the corporate campus, tapping into the resources of the wired network.

Wireless Local Area Network technology has been targeted by analysts as one of the fastest growing sectors in the computing industry. WLANs are used in various vertical and horizontal applications (e.g., retail, manufacturing, logistics, healthcare, education, public space, etc.). Several wireless network standards have become popular, including the 802.11x standards that have been ratified by the Institute of Electrical and Electronics Engineering (IEEE). Exemplary IEEE 802.11x standards include 802.11, 802.11a, 802.11b (also known as Wi-Fi), and 802.11g.

A WLAN may be configured in several ways, including using a centralized wireless switch to support communications with one or more access ports. Through the use of a wireless switch, the network access, security, policy management, and Quality of Service (QoS) features can be unified at the switch level. Deploying a wireless switch in a WLAN can also lower the overall cost of the network infrastructure because of the switch's scalability and flexibility to support existing and future wireless technologies.

However, despite these advantages of switched WLAN systems, there is at least one drawback in that there is no efficient way in these systems to allow a network administrator to monitor the performance of these wireless networks or to detect anomalies in the wireless traffic. One way to monitor the wireless networks is to install wireless sensors throughout the coverage area and sniff the data traffic from the air. However, the traffic captured this way is commonly in encrypted form, and thus is not readily decipherable. Another way is to monitor the wired traffic going into or coming out of a wireless switch. However, this mechanism of monitoring data does not provide the desired wireless information about the traffic.

Some wired network systems may include a mirror port implemented within, for example, a network switch. Through the mirror port, an administrator may observe data that flows to and from one of the several different ports of the network switch. Typically, at any given time, the mirror port allows the administrator to monitor only one port out of the several ports. To monitor a different port, the administrator first stops monitoring the current port before switching to the next, thus making it inconvenient for the administrator to monitor a plurality of ports at any given time.

### SUMMARY OF THE INVENTION

In one embodiment of the present invention, a method is provided. The method comprises receiving, using a wireless controller, data transmitted from one or more wireless transmitters adapted to communicate with a plurality of mobile terminals, receiving descriptive information associated with at least a portion of the received data from the one or more wireless transmitters and providing the received data and the associated descriptive information to a port interface associated with the wireless controller.

In another embodiment of the present invention, a wireless switch is provided having a multi-port interface for use in a switched wireless network. The wireless switch comprises an interface and a controller communicatively coupled to the interface. The controller is adapted to receive data transmitted from a plurality of access ports, wherein the data has an associated descriptive information and provide at least a portion of the received data and the associated descriptive information to a port interface associated with the wireless switch.

In yet another embodiment of the present invention, a system is provided. The system comprises a plurality of mobile terminals and a wireless switch. The wireless switch is adapted to receive data transmitted from the plurality of mobile terminals, wherein the data has associated descriptive information and provide at least a portion of the received data and the associated descriptive information to a port interface associated with the wireless switch.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a communications system including a wireless cell controller, an interface associated with the wireless cell controller, and a plurality of access ports, in accordance with one embodiment of the present invention; and

FIG. 2 is a block diagram of the wireless cell controller and the associated interface, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i,e., a meaning other than that understood by skilled artisans, such a special definition will be expressly set forth in the specification in a definitional manner that directly and unequivocally provides the special definition for the term or phrase.

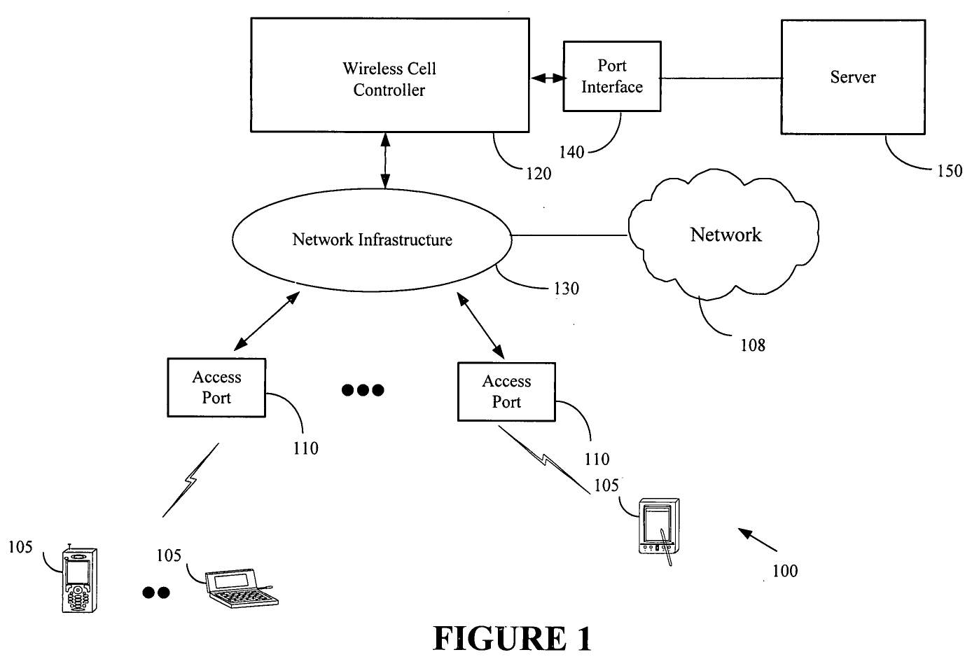

Referring now to FIG. 1, a switched wireless communications system 100 is illustrated, in accordance with one embodiment of the present invention. The communications system 100 includes one or more components that allow mobile terminals 105 to communicate with each other or with other devices over a data network 108. The mobile terminals 105 may communicate with other devices using any suitable communications protocol including, but not limited to, the protocols defined by the IEEE 802.11x standards, such as the 802.11a standard, 802.11b standard, and 802.11g standard.

For ease of illustration, three mobile terminals 105 are depicted, although it should be appreciated that in alternative embodiments, the system 100 may include more or fewer mobile terminals 105. The mobile terminals 105 may take the form of a variety of devices, including, but not limited to, laptop computers, cellular phones, personal digital assistants (PDAs), digital pagers, and wireless cards.

The data network may be a private network or a public network, such as the Internet. As utilized herein, a “network” may refer to one or more communication networks, channels, links, or paths, and systems or devices (such as routers) used to route data over such networks, channels, links, or paths.

The communications system 100 includes one or more wireless access ports 110 communicatively coupled to a wireless cell controller (WCC) 120 through a network infrastructure 130. The wireless cell controller 120 in the illustrated embodiment is a wireless switch, an example of which may be model WS5000 Wireless Switch provided by Symbol Technologies, Incorporation (“Symbol Technologies” hereinafter). The WCC 120 may communicate with the devices coupled to the network 108 using any of a variety of network protocols, including the IEEE 802.3 protocol. Example of access ports 110 may be the AP100 or AP200 models provided by Symbol Technologies. In other embodiments, any suitable type of wireless transceivers may be employed in place of (or in conjunction with) the access ports 110, including access points, for example.

In the illustrated embodiment of FIG. 1, the network infrastructure 130 may be in the form of a network hub or a switch, such as an Ethernet hub or switch. The network infrastructure 130 may include one or more network routers (not shown), in one embodiment.

Although the invention is not so limited, in the illustrated embodiment the WCC 120 and/or the access ports 110 may provide one or more Medium Access Control (MAC) layer functions, including, but not limited to, association management, Quality of Service, roaming, ad hoc mode, authorization, buffer management, and installation/configuration, cyclic redundancy check, channel access, timeout/retransmission, packet acknowledgments, header processing, rate control, beacon processing, and interface to the physical layer. Fragmentation/reassembly and encryption functions may also be performed.

The general flow of data packets within the communications system 100 is described next. In the upstream direction (i.e., from the access port 110 to the WCC 120), the access port 110 receives (encrypted) data packets from the mobile terminals 105 and forwards the received data packets to the WCC 120. In one embodiment, the access port 110 also provides descriptive information associated with the data packets to the WCC 120, where the descriptive information may include information such as a time stamp, relative signal strength index, signal quality, and channel information. The access port 110 may, in one embodiment, encapsulate the descriptive information along with the data from the mobile terminals 105 before transmitting the encapsulated data to the WCC 120. In an alternative embodiment, the WCC 120, instead of the access port 110, may perform the encapsulation feature. The type of descriptive information provided by the access port 110 may vary from one implementation to another, and thus in some embodiments, additional, different, or less descriptive information may be encapsulated with the data packet.

Upon receiving the transmitted data information, along with any associated descriptive information, the WCC 120 buffers, parses, decrypts the received data and delivers it to its intended destination (which may be a mobile terminal 105 or a device communicatively coupled to the network 108). In the reverse direction, the data received by the WCC 120 for transmission to the mobile terminals 105 is buffered, formatted, and encapsulated within a packet and provided via the network infrastructure 130 to the access port 110, which extracts the mobile unit packet from the encapsulated packet and forwards the extracted packet to the appropriate mobile terminal 105.

The WCC 120 of FIG. 1 includes a port interface 140 associated therewith. The communications system of FIG. 1 further includes a processor-based system 150, which in the illustrated embodiment is a server 150. As discussed in greater detail below, in accordance with one or more embodiments of the present invention, the port interface 140 of the WCC 120 can be utilized to provide one or more features that can be useful in analyzing the performance of the communications system 100. These features may include, but are not limited to, detecting wireless intrusion (i.e., detecting anomalies in the wireless traffic), monitoring performance of the wireless communications system 100, and/or sniffing capability. In one embodiment, these feature(s) may be performed by the WCC 120 with which the port interface 140 is associated. In an alternative embodiment, one or more of these features may be performed at the direction of the server 150. In such an embodiment, the port interface 140 may support a command interface to allow the server 150 to communicate with the WCC 120 to perform some of the aforementioned features, such as the wireless intrusion detection. In the event a wireless intrusion is detected, the server 150 can, via the command interface, instruct the WCC 120 to change the current channel of communications.

It should be understood that the configuration of the communications system 100 of FIG. 1 is exemplary in nature, and that fewer, additional, or different components may be employed in other embodiments of the communications system 100. For example, while in the illustrated embodiment, the wireless cell controller 120 communicates with the access port 110 through the network infrastructure 130, in an alternative embodiment, these components may interface with each other without an intervening network infrastructure 130. As another example, in one implementation, the port interface 140 may be integrated within the wireless cell controller 120. Alternatively some or all portions of the port interface 140 may be implemented in a standalone device that is adapted to communicate with the wireless cell controller 120. The manner in which the port interface 140 is associated with the wireless cell controller 120 is a matter of design choice, and thus may vary from one implementation to another. Similarly, other variations may be made to the illustrated configuration of the communications system 100 without deviating from the spirit and scope of the invention.

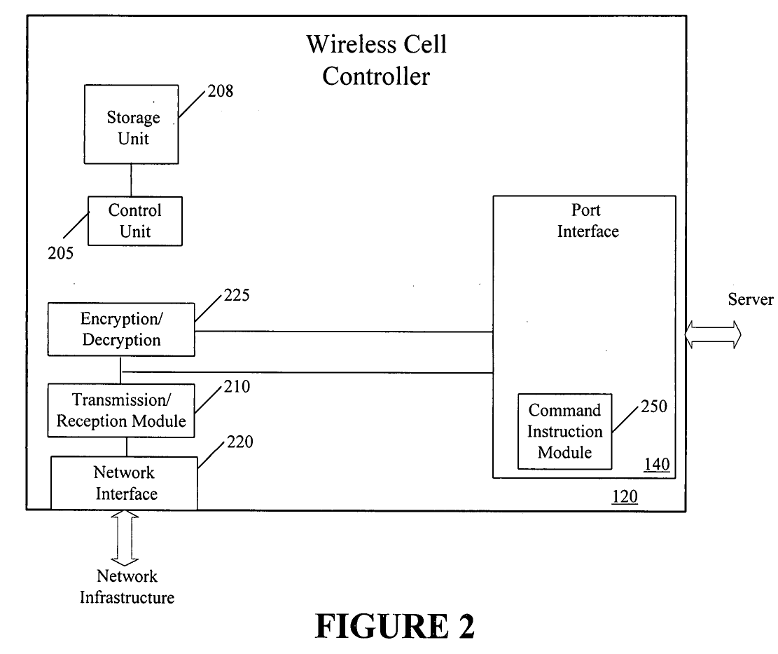

Referring now to FIG. 2, a block diagram of the wireless cell controller 120 and the associated port interface 140 of FIG. 1 is illustrated, in accordance with one embodiment of the present invention. In the illustrated embodiment of FIG. 2, the port interface 140 is integrated within the WCC 120.

The WCC 120 includes a control unit 205 and a storage unit 208 that is communicatively coupled to the control unit 205. An example of the control unit 205 may be a processor. The illustrated embodiment of the WCC 120 further includes a module 210 for transmitting and receiving data to and from the access ports 110 through a network interface 220. The data received from the access ports 110 may include data packets transmitted by the mobile terminals 105, as well as the descriptive information (discussed above) associated with these data packets. In the illustrated embodiment, the network interface 220 of the WCC 120 is communicatively coupled to the network infrastructure 130 (shown in FIG. 1). In an alternative embodiment, a plurality of ports (not shown) may be utilized to connect the WCC 120 to the access ports 110 without an intervening network infrastructure 130.

The WCC 120 further includes an encryption/decryption module 225. The module 225 decrypts data that is received from the access ports 110, and encrypts data that is transmitted to the access ports 110. This extends the wireless security domain, protecting communications from the access ports 110 to the WCC 120. Those skilled in the art having the benefit of this disclosure will appreciate that the particular encryption and decryption algorithms employed in a given communications system can vary from one implementation to another.

In the illustrated embodiment, the server 150 (see FIG. 1) may access the WCC 120 via the port interface 140 to perform a variety of desired features, including, but not limited to, monitoring performance of the wireless communications system 100, multi-port sniffing of transmitted and received data, and/or detecting wireless intrusion. The server 150, can be an open platform enabling a plurality of software functions by vendors other than the switch manufacturer. Each of these features is described below.

With respect to the monitoring capability, the port interface 140 allows an administrator situated at the server 150 to view and analyze the data packets (e.g., 802.11 packets in the illustrated example) that are transmitted to and from the WCC 120 by the mobile terminals 105 via the access ports 110. Implementing the port interface 140 in association with (or as part of) the WCC 120 can be advantageous because substantially all of the data transmitted by the access ports 110 passes through the WCC 120, and thus can be readily monitored via the port interface 140. In accordance with one embodiment of the present invention, because the WCC 120 is a centralized switch through which a plurality of access ports 110 transmits data, it is possible to monitor data transmitted by these pluralities of access ports 110 at any given time. Alternatively, if desired, data from less than all of the access ports 110 under the control of the WCC 120 can be monitored.

In one embodiment of the present invention, the port interface 140 may also allow the administrator to view and analyze the descriptive information associated with the data packets. As noted earlier, the descriptive information may include time stamp, relative signal strength index, signal quality, access port identifier, and/or channel information associated with the transmission of the data packets from the access ports 110. The descriptive information may be encapsulated, for example, with the 802.11 data packets before the encapsulated information is provided to the server 150 through the port interface 140. Having access to the encapsulated information can be useful to an administrator desiring to evaluate the performance of the wireless communications system 100 or to trouble shoot communications problems. This is because the descriptive information associated with the data packets (e.g., 802.11 packets, for example) provides the administrator with a wide array of information (e.g., data stamp, access port identifier, transmission channel characteristics) to identify problematic areas in the communications system 100. In one embodiment, if desired, the port interface 140 may be utilized to “dump” or save the encapsulated data to a storage unit (not shown) of the server 150 or to a storage unit of another device.

Although not so limited, in one embodiment, the following encapsulated format may be employed: the element ID |length|data|. The element ID field may include information such as the timestamp, RSSI, Channel Number, 802.11 packet, and the like. The length field may include the length of the data that is stored in the data field.

As noted above, in one embodiment, the port interface 140 may also support data sniffing capabilities. Through the port interface 140, the server 150 can gain access to data that is, for example, transmitted to the WCC 120 from the mobile terminals 105. Because the port interface 140 is implemented in association with (or as part of) the WCC 120, the server 150 can utilize this port interface 140 to access decrypted data. In contrast, conventional mirror ports that are typically implemented in wired network hubs (at the network infrastructure level), do not have access to decrypted data because the decryption is performed by the WCC 120.

In one embodiment, the port interface 140 may also include a command instruction module 250 that allows two-way communications between the server 150 and the WCC 120. Through the module 250, the server 150 may perform one or more desired tasks. For example; the server 150 may instruct the WCC 120 to communicate with another access port 110 in response to determining a denial of service attack on the present communications channel. As another example, the server 150, acting as a remote wireless intrusion detection device, may inform the WCC 120 to disassociate a malice mobile terminal 105, or drop harmful packets.

Furthermore, the server 150, in one embodiment, can perform complex spectral analysis and descriptive information received from the access ports 110 via the WCC 120. This enables the server 150 to reconfigure the WCC 120 and respective access ports 110, so as to optimally reallocate frequency channel assignments (dynamic channel assignment) or change antenna patterns to improve wireless system performance.

In one embodiment the server 150, negotiates with the WCC 120, via the port interface 140, a set of services supported by the WCC 120 and associated access ports 110. This enables various classes of servers, hosting varying degrees of functions, to be interconnected, and for the WCC 120, to dynamically configure itself to provide the necessary set of data and descriptive information to the server 150. The communications from the WCC 120, and the server 150, may be encapsulated in a publicly published standard described using XML and may describe discovery and UDDI (Universal Description, Discovery, and Integration).

It should be appreciated that only selected components of the WCC 120 of FIG. 2 are shown that are helpful in understanding the various embodiments of the invention, and that in alternative embodiments, the WCC 120 may include fewer, additional, or different components without deviating from the spirit and scope of the invention.

In summary, in accordance with one embodiment of the present invention, the WCC 120 includes an associated port interface 140 that provides one or more useful features. For example, in one embodiment, the port interface 140 may be utilized to monitor the data that is received from and/or transmitted to the WCC 120, where the data may be monitored in substantially real-time. In another embodiment, the port interface 140 may support data dump (i.e., allow a user to store the monitored data to a storage device, which may be located within the WCC 120 or in an external device). In yet another embodiment, the port interface 140 may be responsive to commands received from the server 150 to allow an administrator to direct the WCC 120 to execute desired task(s). For example, the server 150 may instruct the WCC 120 to change the current communications channel that is being utilized to a different one for improved service.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities Within the computer system's memories or registers or other such information storage, transmission or display devices.

Those skilled in the art will appreciate that the various system layers, routines, or modules illustrated in the various embodiments herein may be executable control units (such as the control unit 205 (see FIG. 2)). The control unit 205 may include a microprocessor, a microcontroller, a digital signal processor, a processor card (including one or more microprocessors or controllers), or other control or computing devices. The storage devices 208 referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 205 causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
receiving, using a wireless controller, data transmitted from one or more wireless transmitters adapted to communicate with a plurality of mobile terminals;
receiving descriptive information associated with at least a portion of the received data from the one or more wireless transmitters; and
providing the received data and the associated descriptive information to a port interface associated with the wireless controller.

2. The method of claim 1, wherein the act of providing comprises encapsulating the descriptive information with the data in a packet and providing the encapsulated packet to the port interface.

3. The method of claim 1, wherein the act of providing comprises providing the data and the associated descriptive information to the port interface for at least one of storage in a remote device and further processing.

4. The method of claim 1, wherein receiving the descriptive information comprises receiving the descriptive information encapsulated with the data in a packet, wherein the descriptive information comprises at least one high resolution timestamp associated with the data and channel information associated with the transmission of the data, wherein the channel information includes at least one of signal quality and relative signal strength index.

5. The method of claim 1, further comprises receiving a request from a remote unit through the port and further causing the wireless controller to perform at least one task responsive to the received request.

6. The method of claim 5, wherein the wireless transmitters comprise a plurality of access ports, and wherein the wireless controller communicates with a first access port of the plurality of access ports over a first communication channel, and wherein, in response to receiving the request, the wireless controller communicates with the first access port over a channel different from the first channel.

7. A wireless switch, comprising:
an interface; and
a controller communicatively coupled to the interface, the controller adapted to:
receive data transmitted from a plurality of access ports, wherein the data has associated descriptive information; and
provide at least a portion of the received data and the associated descriptive information to a port interface associated with the wireless switch.

8. The wireless switch of claim 7, wherein the controller is adapted to provide the descriptive information with the data to the port interface.

9. The wireless switch of claim 7, wherein the controller is adapted to provide at least a portion of the data and the associated descriptive information to the port interface for substantial real-time monitoring using the remote device.

10. The wireless switch of claim 7, wherein the controller is further adapted to receive a request from a remote unit through the port interface and wherein the controller is adapted to cause the wireless switch to perform at least one task responsive to the received request.

11. The wireless switch of claim 7, wherein the controller is responsive to commands received from a remote device.

12. The wireless switch of claim 7, wherein the controller is adapted to provide the data and associated descriptive information to the port interface for storage in a storage unit of a remote device.

13. The wireless switch of claim 7, wherein the descriptive information comprises at least one of a timestamp associated with the data and channel information associated with the transmission of the data, wherein the channel information includes at least one of signal quality, channel number to use, and relative signal strength index.

14. A system, comprising:
a plurality of mobile terminals;
a wireless switch adapted to:
receive data transmitted from the plurality of mobile terminals, wherein the data has an associated descriptive information; and
provide at least a portion of the received data and the associated descriptive information to a port interface associated with the wireless switch.

15. The system of claim 14, further comprising at least one access port adapted to receive the data from the mobile terminals and further adapted to transmit the data to the wireless switch.

16. The system of claim 15, wherein the wireless switch is adapted to receive the data and the descriptive information associated with the data.

17. The system of claim 14, wherein the wireless switch provides an encapsulated packet including the data and the associated descriptive information.

18. The system of claim 14, wherein the wireless switch is adapted to receive commands from a remote device and perform at least one task responsive to the received commands.

19. The system of claim 14, wherein the descriptive information comprises at least one of a timestamp associated with the data and channel information associated with the transmission of the data, wherein the channel information includes at least one of signal quality and relative signal strength index.

20. The system of claim 14, further comprising a remote device that is adapted to communicate with the wireless switch via the port interface, wherein the remote device is at least one of a wireless sniffer, performance monitor, and wireless intrusion detection server.

21. An apparatus, comprising:
means for receiving, using a wireless controller, data transmitted from a plurality of access ports, wherein the data has associated descriptive information; and
means for providing at least a portion of the received data and the associated descriptive information to a port interface associated with the wireless controller.
